(19) United States
(12) Patent Application Publication
(10) Pub. No.: US 2026/0193033 A1
(43) Pub. Date: Jul. 9, 2026

(54) FAN CONTROL SYSTEM FOR ELECTRIC REFUSE VEHICLE

(71) Applicant: Oshkosh Corporation, Oshkosh, WI (US)

(72) Inventors: Jeff Verhagen, Oshkosh, WI (US); Greg Steffens, Oshkosh, WI (US)

(21) Appl. No.: 19/439,226

(22) Filed: Jan. 2, 2026

Related U.S. Application Data
(60) Provisional application No. 63/741,589, filed on Jan. 3, 2025.

(51) Int. Cl. B65F 3/12

(52) U.S. Cl. CPC B65F 3/12

(57) ABSTRACT

A refuse vehicle is provided. The refuse vehicle includes a chassis, a body coupled to the chassis, a cab coupled to the chassis forward of the body, a shroud coupled to the cab, a heat exchanger, a fan, a lift assembly, and a controller. The shroud at least partially defines an inlet and an outlet. The heat exchanger is disposed within the shroud. The fan is positioned to drive airflow through the shroud and the heat exchanger from the inlet toward the outlet. The lift assembly is rotatably coupled to the body and configured to perform a refuse collection operation. The controller is configured to determine whether the refuse collection operation is being performed and to control the fan to drive airflow through the shroud and the heat exchanger, from the outlet toward the inlet, in response to determining that the refuse collection operation is being performed.

### CROSS-REFERENCE TO RELATED APPLICATIONS

The present application claims the benefit of and priority to U.S. Provisional Ser. No. 63/741,589 , filed on Jan. 3, 2025, the entire contents of which are hereby incorporated by reference herein.

### BACKGROUND

The present application relates generally to the field of refuse vehicles and, in particular, electrically powered refuse vehicles.

### SUMMARY

An exemplary embodiment of the present disclosure relates to a refuse vehicle. The refuse vehicle includes a chassis, a body, a cab, a shroud, a heat exchanger, a fan, a lift assembly, and a controller. The body is coupled to the chassis. The cab is coupled to the chassis forward of the body. The shroud is coupled to the cab. The shroud at least partially defines an inlet positioned along a front side of the shroud and an outlet positioned along a rear side of the shroud. The heat exchanger is disposed within the shroud. The fan is positioned to drive airflow through the shroud and the heat exchanger from the inlet toward the outlet. The lift assembly is rotatably coupled to the body and configured to perform a refuse collection operation. The refuse collection operation includes engaging a refuse container and lifting the refuse container above the cab to deposit refuse from the refuse container into the body. The controller is configured to determine whether the refuse collection operation is being performed. The controller is also configured to control the fan to drive airflow through the shroud and the heat exchanger, from the outlet toward the inlet, in response to determining that the refuse collection operation is being performed.

Another exemplary embodiment of the present disclosure relates to a vehicle. The vehicle includes a chassis, a cab, a shroud, a heat exchanger, a fan, a working component, and a controller. The cab is coupled to the chassis. The shroud is coupled to the cab. The shroud at least partially defines a first airflow opening and a second airflow opening. The heat exchanger is disposed within the shroud. The fan is positioned to drive airflow through the shroud and the heat exchanger from the first airflow opening toward the second airflow opening. The working component is coupled to the chassis and movable relative to the cab. The controller is configured to determine whether the working component is in operation. The controller is also configured to control the fan to drive airflow through the shroud and the heat exchanger, from the second airflow opening toward the first airflow opening, to reduce ingestion of debris associated with operation of the working component, in response to determining that the working component is in operation.

Another exemplary embodiment of the present disclosure relates to a method for controlling airflow through a shroud disposed on a cab of a refuse vehicle. The method includes causing, by a controller, a fan disposed within the shroud to drive airflow through the shroud, from an inlet defined at least in part by the shroud toward an outlet defined at least in part by the shroud. The method also includes receiving, by the controller, an indication of a first condition. The method also includes, in response to receiving the indication of the first condition, causing, by the controller, the fan to drive airflow through the shroud, from the outlet toward the inlet.

Another exemplary embodiment of the present disclosure relates to a refuse vehicle. The refuse vehicle includes a chassis, a cab coupled to the chassis, a body coupled to the chassis, a lift assembly rotatably coupled to the body, a shroud coupled to the cab, and a fan disposed within the shroud. The cab has a front face. The lift assembly is configured to perform a refuse collection operation. The refuse collection operation includes selectively engaging a refuse container and lifting the refuse container above the cab to deposit refuse from the refuse container into the body. The shroud and the cab define an internal volume between the cab and the shroud. The shroud partially defines a first inlet positioned along a front side of the shroud and in fluid communication with the internal volume. The shroud partially defines an outlet positioned along a rear side of the shroud and in fluid communication with the internal volume. The fan is positioned proximate the outlet. The fan is configured to direct air from the first inlet toward the outlet during normal operation and to direct air from the outlet toward the first inlet during a portion of the refuse collection operation.

In some embodiments, the refuse vehicle further includes a sensor configured to output a signal indicative of an occurrence of the refuse collection operation and a controller configured to receive the signal and to control the fan. In some embodiments, the shroud defines a second inlet arranged such that airflow along the front face of the cab enters the internal volume through the second inlet. In some embodiments, the fan is configured to direct air from the first inlet and the second inlet toward the outlet during normal operation and to direct air from the outlet toward the first inlet and the second inlet during a portion of the refuse collection operation. In some embodiments, the refuse vehicle includes a cooling assembly disposed within the internal volume and the fan is coupled to the cooling assembly.

Another exemplary embodiment of the present disclosure relates to a vehicle. The vehicle includes a chassis, a cab coupled to the chassis, a body coupled to the chassis, an implement coupled to the body, a cowl coupled to one of the cab or the body, and a fan disposed within the cowl. The cowl defines an inlet and an outlet for airflow therethrough. The fan is configured to direct air from the inlet toward the outlet during normal operation and to direct air from the outlet toward the inlet during at least a portion of an operation of the implement. In some embodiments, the vehicle further includes a thermal management system disposed within the cowl. In some embodiments, the fan is coupled to the thermal management system.

Another exemplary embodiment of the present disclosure relates to a method of directing airflow through a cowl of a vehicle. The method includes receiving a signal from one of an implement sensor or a user input device. The method further includes determining, based on the signal, whether an implement of the vehicle is operating. Finally, the method includes reversing a direction of rotation of a fan disposed within the cowl based on a determination that the implement of the vehicle is operating.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a left side view of a vehicle, according to an exemplary embodiment;

FIG. 2 is a perspective view of a chassis of the vehicle of FIG. 1, according to an exemplary embodiment;

FIG. 3 is a perspective view of the vehicle of FIG. 1 configured as a front-loading refuse vehicle, according to an exemplary embodiment;

FIG. 4 is a left side view of the front-loading refuse vehicle of FIG. 3 configured with a tag axle, according to an exemplary embodiment;

FIGS. 5 and 6 are block diagrams of a thermal management system for the vehicle of FIG. 1, according to an exemplary embodiment;

FIGS. 7-9A are various views of a configuration of the vehicle of FIG. 1 including a cowl assembly for housing various components of the vehicle, according to another exemplary embodiment;

FIGS. 9B-9F are various views of the cowl assembly of FIG. 7 with an alternative drip channel assembly, according to exemplary embodiments;

FIGS. 9G and 9H are various views of the drip channel assembly of FIG. 9B; according to exemplary embodiments;

FIG. 10 is a perspective view of the vehicle of FIG. 7 showing a visor of the cowl assembly, according to an exemplary embodiment;

FIG. 11 is a perspective view of the vehicle of FIG. 7 showing a core assembly positioned within the cowl assembly, according to an exemplary embodiment;

FIG. 12 is a left section view of the vehicle of FIG. 7, according to an exemplary embodiment;

FIGS. 13-18 are various views of the vehicle of FIG. 7 with a rear portion of the cowl assembly removed, according to an exemplary embodiment;

FIG. 19 is a left section view of the vehicle of FIG. 7 with a direction of airflow reversed, according to an exemplary embodiment;

FIG. 20 is a block diagram of a control system for a refuse vehicle, according to an exemplary embodiment; and

FIG. 21 is a flow diagram of a method of directing airflow through a cowl of a refuse vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Refuse vehicles (e.g., a garbage truck, a waste collection truck, a sanitation truck, etc.) are vehicles configured to collect, process, and transport refuse. A refuse vehicle may include a thermal management system to cool various heat generating components of the refuse vehicle. The thermal management system may include an air cooled heat exchanger (e.g., a heat dissipater, radiator, etc.), to enable dissipation of heat to an environment surrounding the refuse vehicle. Air may be routed through fins along an outer surface of the heat exchanger during operation to facilitate cooling. Ingression of debris (e.g., dirt, oils, etc.) into the heat exchanger, such as into spaces between the fins and onto the fins, can reduce the efficiency of the thermal management system, by blocking or restricting the flow of air, or damaging various components of the thermal management system (e.g., fans, sensors, pumps, etc.).

Referring generally to the Figures, a refuse vehicle is shown that includes a fan control system configured to control a direction of airflow through one or more heat exchangers of a thermal management system to reduce the risk of ingesting dirt and other contaminants and debris into the one or more heat exchangers during operation. According to an exemplary embodiment, the thermal management system, including the one or more heat exchangers and fan(s) driving airflow through the one or more heat exchangers, is disposed within a cowl assembly onboard the refuse vehicle. The cowl assembly may facilitate introduction of ram air through the heat exchangers during transit operations.

In some embodiments, the fan control system is configured to reverse operation of the fans responsive to operation of an implement (e.g., a working component, a lift system, etc.) of the refuse vehicle. For example, the fan control system may be configured to reverse a direction of fan rotation to reverse the direction of airflow through the cowl assembly responsive to an indication that the implement is being operated (e.g., responsive to signals from a user input device and/or sensor data from a sensor configured to detect the operation of the implement). Such an arrangement can prevent ingestion of debris, resulting from operation of the implement (e.g., such as liquid or other debris from a refuse container being lifted above the vehicle by the lift system), from being drawn into an inlet of the cowl assembly and through the heat exchangers.

### Overall Vehicle

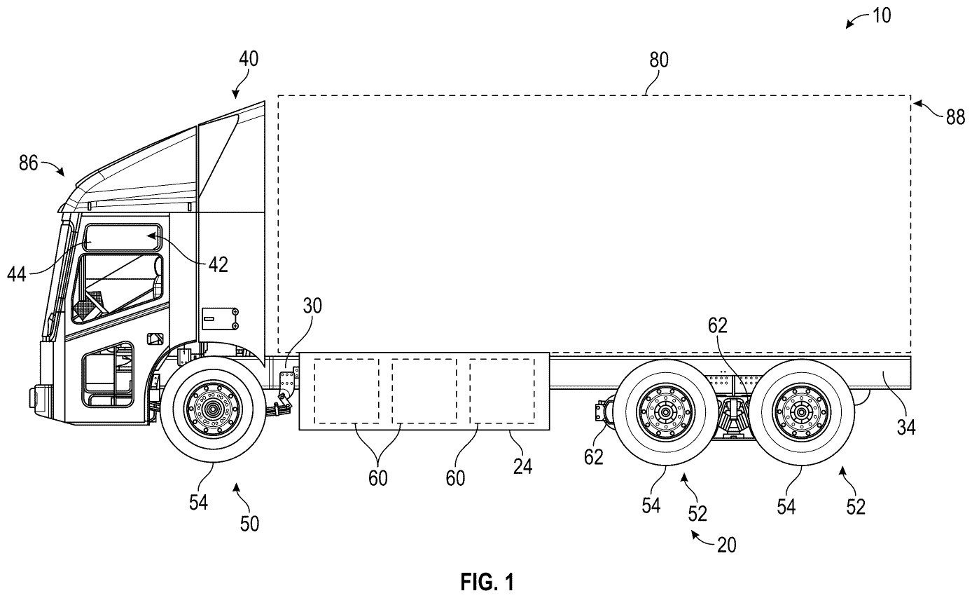

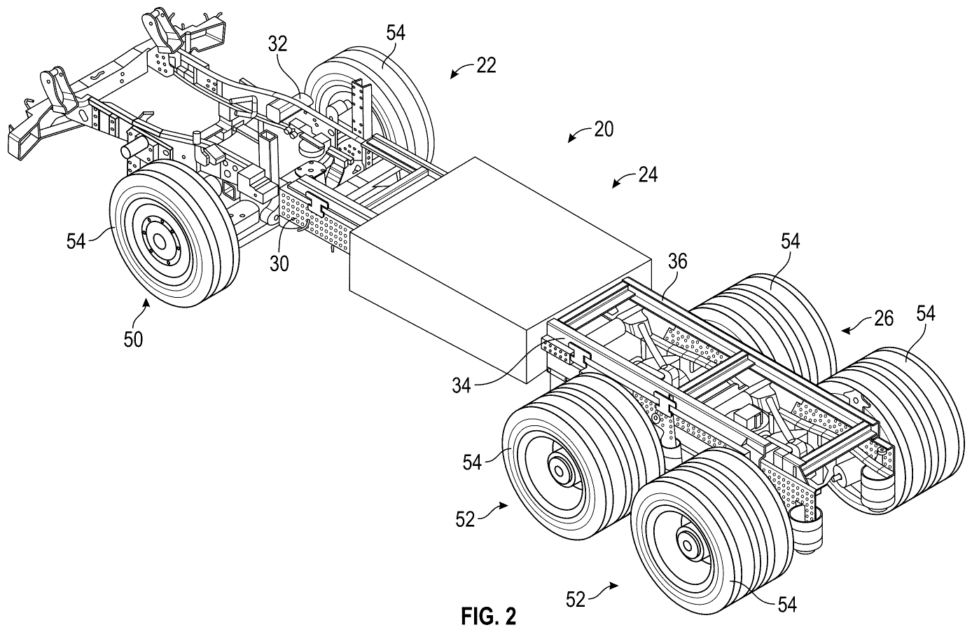

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles 52 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the front axle 50 and/or the rear axles 52 to propel the vehicle 10. Additionally, or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

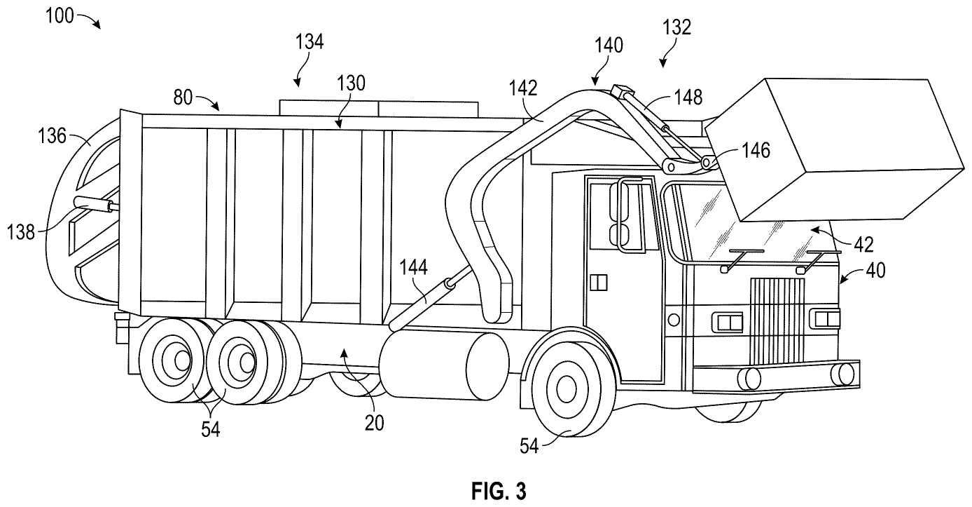

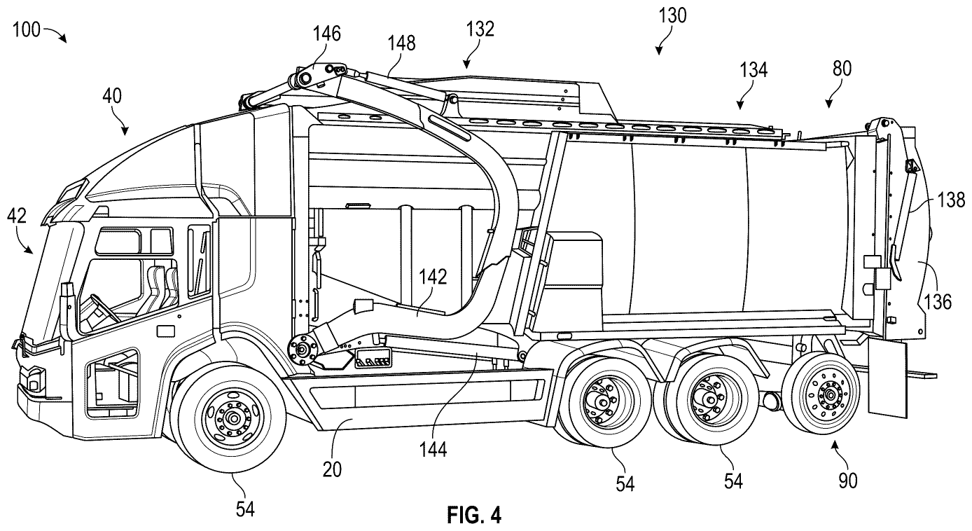

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3 and 4 illustrate an example of how the vehicle 10 may be configured for specific applications. Although only one configuration is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### Front-loading Refuse Vehicle

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle that is configured to engage with containers at a front end of the refuse vehicle. In other embodiments, the refuse vehicle 100 is configured as a rear-loading refuse vehicle or a side-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned rearward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the refuse vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively couple the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### Thermal Management System

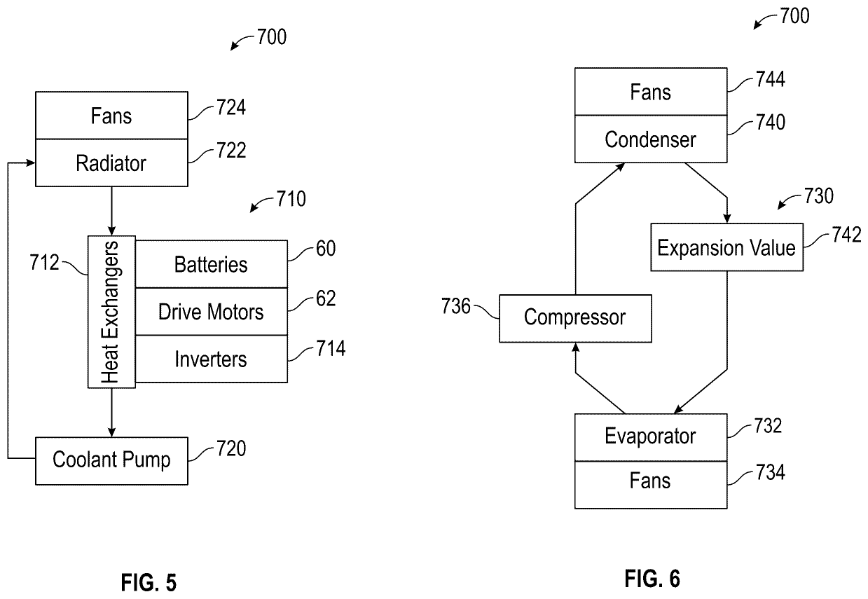

Referring to FIGS. 5 and 6, the vehicle 10 includes a cooling system (e.g., a heat dissipation system, a heating, ventilation, and air conditioning (HVAC) system, a temperature control system, a thermal management system, etc.), shown as thermal management system 700. The thermal management system 700 is configured to vary the temperatures of (e.g., cool) one or more components of the vehicle 10 and/or one or more spaces within the vehicle 10. By way of example, the thermal management system 700 may be configured to cool a hydraulic system, an electric system, or another sub-system onboard the vehicle 10 that generate heat during operation. By way of another example, the thermal management system 700 may provide cool air to a space occupied by an operator. By way of another example, the thermal management system 700 may warm the air within a space occupied by the operator (e.g., the cab interior 42).

Referring to FIG. 5, the thermal management system 700 includes a heat dissipation circuit, shown as coolant circuit 710. The coolant circuit 710 is configured to dissipate thermal energy from one or more components of the vehicle 10 to the surrounding atmosphere, decreasing or maintaining a temperature of those components. The coolant circuit 710 includes one or more heat transfer devices (e.g., water jackets, fins, etc.), shown as heat exchangers 712 that place one or more components in thermal communication with the coolant circuit 710. One heat exchanger 712 may be coupled to multiple components. Alternatively, each component may be coupled to a separate heat exchanger 712.

As shown, the heat exchangers 712 are coupled to the batteries 60, the drive motors 62, and one or more power conditioners or power converters, shown as inverters 714. The inverters 714 may be electrically coupled to the batteries 60 and the drive motors 62. The inverters 714 may convert direct current (DC) electrical energy from the batteries 60 to alternating current (AC) electrical energy and provide the AC electrical energy to the drive motors 62. Additionally, or alternatively, the inverters 714 may convert AC electrical energy from the drive motors 62 to DC electrical energy and provide the DC electrical energy for storage in the batteries 60. The heat exchangers 712 may thermally couple to the batteries 60, the drive motors 62 and/or the inverters 714 to remove thermal energy generated during operation (e.g., due to resistance). In other embodiments, the heat exchangers 712 are coupled to other components of the vehicle 10. By way of example, the heat exchangers 712 may be coupled to pumps, compressors, actuators, or other components of the vehicle 10 that generate thermal energy during operation.

The heat exchangers 712 are fluidly coupled to a driver or actuator, shown as coolant pump 720. The coolant pump 720 is configured to receive coolant at a low pressure and provide a flow of fluid at an elevated pressure. As shown, an inlet of the coolant pump 720 is fluidly coupled to the heat exchangers 712, such that the coolant pump 720 is downstream of the heat exchangers 712. In other embodiments, the coolant pump 720 is positioned upstream of the heat exchangers 712.

The coolant pump 720 is fluidly coupled to a heat dissipater, radiator core, or heat exchanger, shown as radiator 722. The radiator 722 is fluidly coupled to the heat exchangers 712, forming a closed loop for coolant flow. In operation, the coolant pump 720 initiates a flow of coolant, which causes the coolant to flow through the heat exchangers 712. The heat exchangers 712 transfer thermal energy from the batteries 60, the drive motors 62, and/or the inverters 714 to the coolant. The coolant is received by the radiator 722, which transfers thermal energy from the coolant into the surrounding atmosphere.

In some embodiments, the coolant circuit 710 further includes one or more air movers, coolers, or blowers, shown as fans 724. The fans 724 are coupled to the radiator 722. The fans 724 may be positioned to direct air from the surrounding atmosphere through the radiator 722 (e.g., across fins of the radiator 722). The fans 724 may improve the cooling performance of the coolant circuit 710 by increasing the heat transfer from the radiator 722 to the surrounding atmosphere.

Referring to FIG. 6, the thermal management system 700 further includes a refrigeration circuit or air conditioning circuit, shown as air conditioning circuit 730. The air conditioning circuit 730 is configured to transfer thermal energy from the cab interior 42 to the surrounding atmosphere, decreasing or maintaining a temperature of air within the cab 40 to improve operator comfort. Operation of the air conditioning circuit 730 may be controlled by an operator (e.g., through a user interface that provides commands to a controller that controls the air conditioning circuit 730).

The air conditioning circuit 730 includes a heat exchanger or radiator core, shown as evaporator 732. The evaporator 732 is in fluid communication with the cab interior 42 such that air passes through the evaporator 732 and into the cab interior 42. In some embodiments, the evaporator 732 is positioned within the cab interior 42.

In some embodiments, the air conditioning circuit 730 includes one or more air movers or blowers, shown as fans 734. The fans 734 are coupled to the evaporator 732. The fans 734 may be positioned to direct air from the cab interior 42 and/or from the surrounding atmosphere through the evaporator 732 (e.g., across fins of the evaporator 732). The fans 734 may improve the cooling performance of the air conditioning circuit 730 by increasing the heat transfer from the air that passes through the evaporator 732 to the evaporator 732.

An outlet of the evaporator 732 is fluidly coupled to a compressor 736. The compressor 736 is configured to receive refrigerant at a low pressure and provide a flow of the refrigerant at an elevated pressure. An outlet of the compressor 736 is fluidly coupled to a heat dissipater, radiator core, or heat exchanger, shown as condenser 740. An outlet of the condenser 740 is fluidly coupled to an expansion valve or throttling valve, shown as expansion valve 742. The outlet of the expansion valve 742 is fluidly coupled to the inlet of the evaporator 732, forming a closed loop.

In some embodiments, the air conditioning circuit 730 includes one or more air movers or blowers, shown as fans 744. The fans 744 are coupled to the condenser 740. The fans 744 may be positioned to direct air from the surrounding atmosphere through the condenser 740 (e.g., across fins of the condenser 740). The fans 744 may improve the cooling performance of the air conditioning circuit 730 by increasing the heat transfer from the condenser 740 to the surrounding atmosphere.

In operation, the compressor 736 initiates a flow of compressed refrigerant, which flows into the condenser 740. The condenser 740 transfers thermal energy from the refrigerant into the surrounding atmosphere. The cooled refrigerant passes through the expansion valve 742, which expands the refrigerant, further cooling the refrigerant. The cooled refrigerant passes through the evaporator 732, where thermal energy from the cab interior 42 is transferred to the refrigerant. The heated refrigerant then returns to the compressor 736.

In some embodiments, the vehicle 10 includes a hydraulic system. By way of example, the vehicle 10 may include a pump that provides hydraulic fluid to one or more hydraulic actuators (e.g., hydraulic motors, hydraulic cylinders, etc.). Hydraulic fluid (e.g., oil) may increase in temperature throughout operation of the hydraulic system. In some embodiments, the thermal management system 700 includes a hydraulic fluid radiator or heat exchanger (e.g., similar to the radiator 722, a transmission oil cooler), through which the hydraulic fluid flows. The hydraulic fluid radiator may transfer heat from the hydraulic fluid to the surrounding atmosphere.

### Cowl Position and Thermal Management

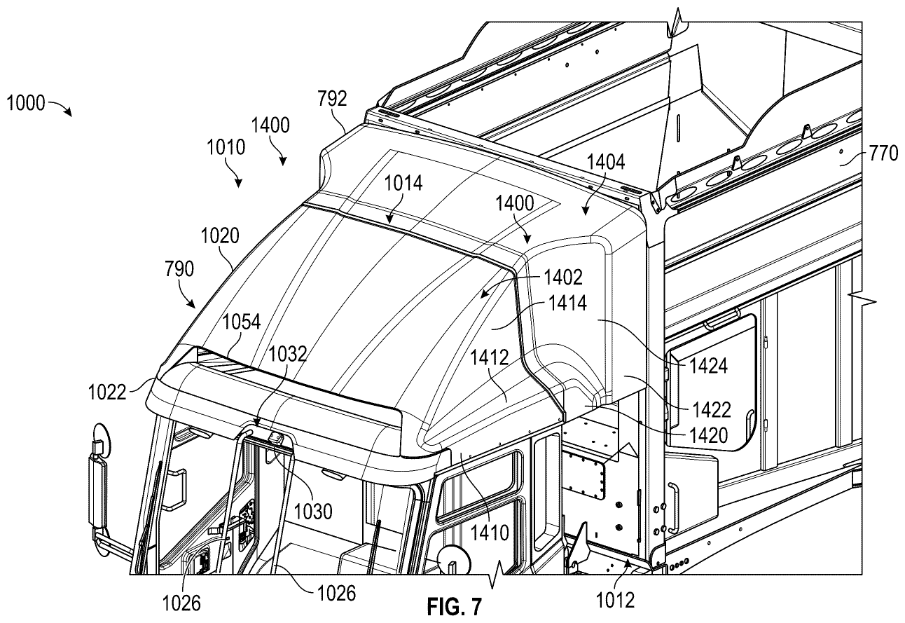

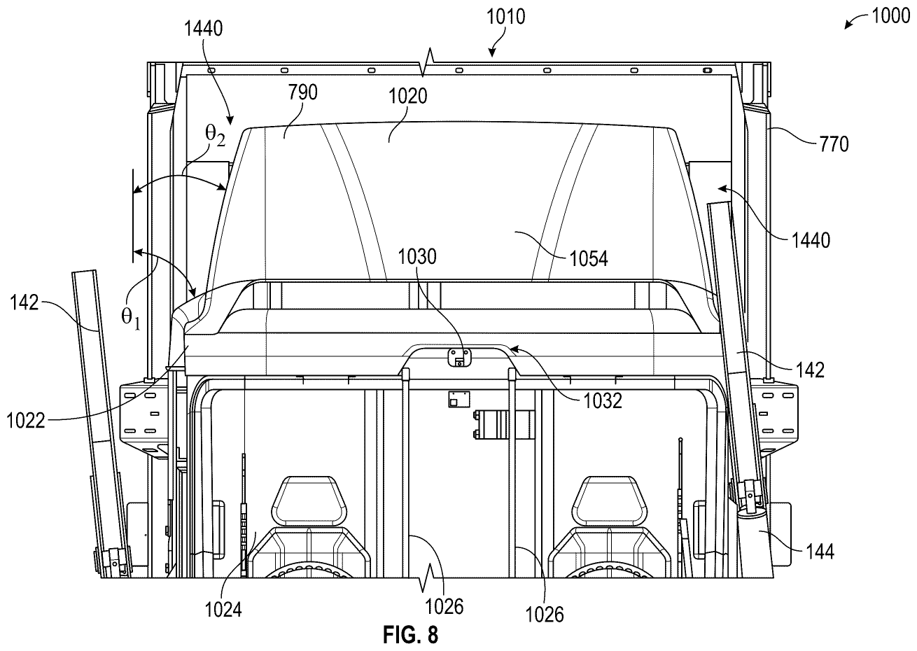

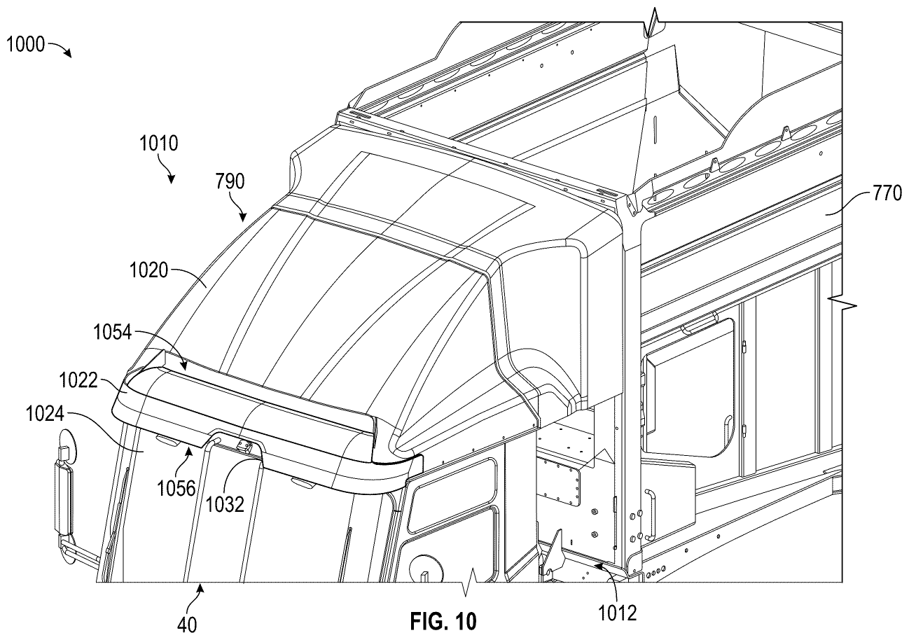

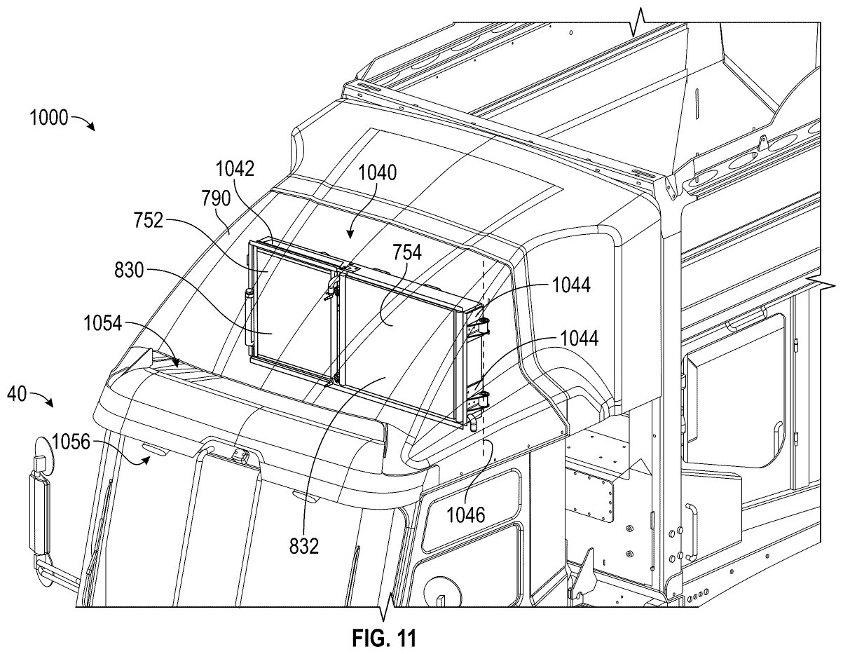

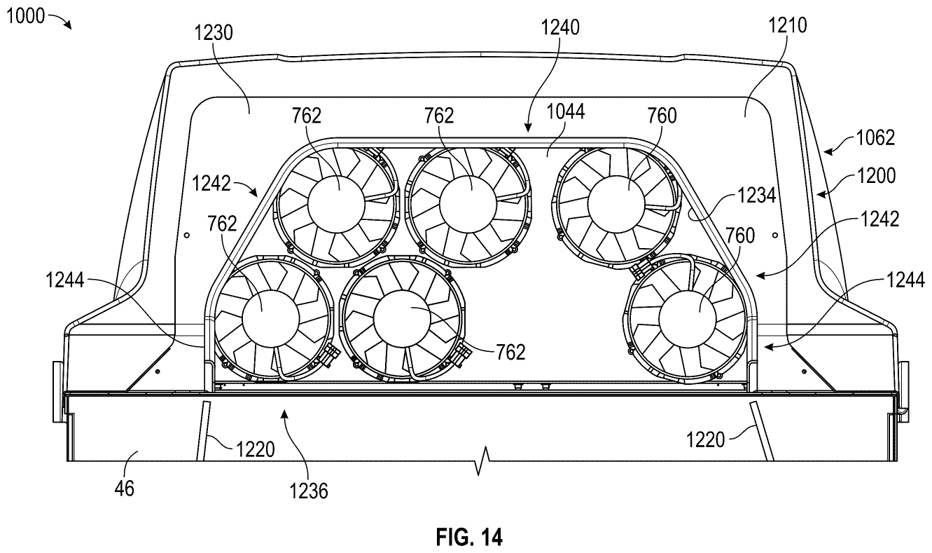

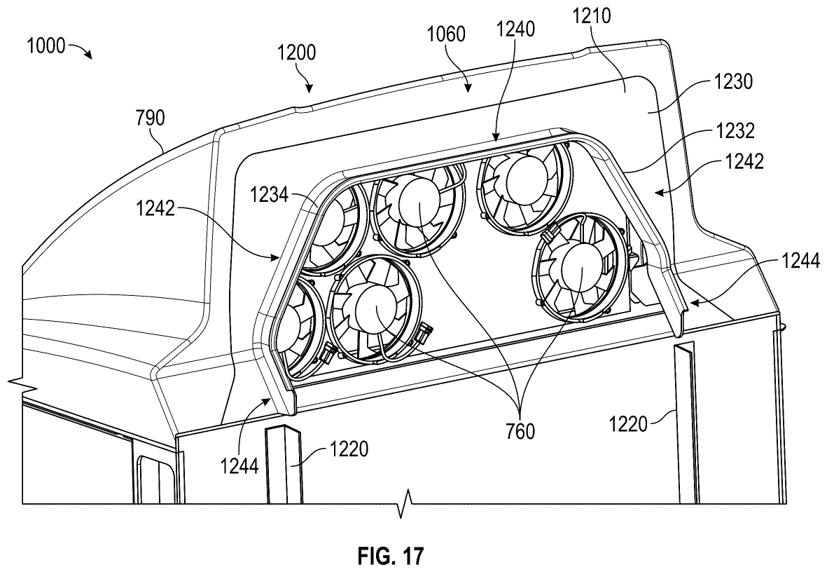

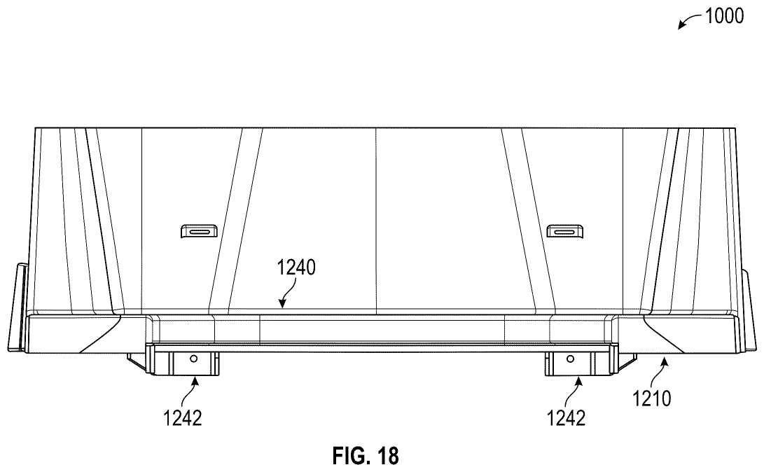

Referring to FIGS. 7-9A and 10-18, a vehicle 1000 is shown as an exemplary configuration of vehicle 10. Accordingly, any description with respect to the vehicle 10 may apply to the vehicle 1000, except as otherwise specified.

As shown in FIGS. FIGS. 7-9A and 10-18, the application kit 80 of the vehicle 1000 includes a container or structure, shown as body 770, positioned rearward of the cab 40. As shown, the body 770 is substantially rectangular (e.g., a rectangular prism). As shown, the body 770 extends above (e.g., is taller than) the cab 40. By way of example, the body 770 may act as the refuse compartment 130 of the refuse vehicle 100.

As shown, the vehicle 1000 includes a cowl assembly 1010 including a first cowl portion, shown as front shroud 790, and a second cowl portion, shown as rear shroud 792. The front shroud 790 is coupled to the cab 40 and positioned above the cab 40. The rear shroud 792 is coupled to the body 770 of the application kit (e.g., a refuse compartment 130 when the vehicle 1000 is configured as a refuse vehicle) and extends forward, toward the front shroud 790. A space, volume, or compartment, shown as storage compartment 1012, is defined between the body 770, the cab 40, the rear shroud 792, and the chassis 20. Specifically, the storage compartment 1012 is positioned below the rear shroud 792, above the chassis 20, forward of the body 770, and behind the cab 40.

The front shroud 790 and the rear shroud 792 of the cowl assembly 1010 are movable relative to one another. In some embodiments, the body 770 is capable of moving relative to the chassis 20 and the cab 40. In some such embodiments, the body 770 can be raised and lowered relative to the chassis 20 between a lowered or operating position and an elevated position. In an exemplary embodiment, the body 770 is rotatably coupled to the chassis 20 near the rear end of the chassis 20, and the body 770 rotates about a lateral axis (i.e., a horizontal axis) such that the front end of the body 770 raises and lowers. In other embodiments, the entire body 770 raises and lowers. In some embodiments, the vehicle 1000 includes an actuator (e.g., a hydraulic cylinder, an electric linear actuator, a pneumatic cylinder, etc.) that is coupled to the chassis 20 and the body 770. The actuator is configured to selectively move the body 770 between the raised position and the lowered position. In some such embodiments, when the body 770 is raised, the rear shroud 792 is raised relative to the front shroud 790. Raising the rear shroud 792 in this way may facilitate access to components within the front shroud 790 (e.g., for cleaning or maintenance).

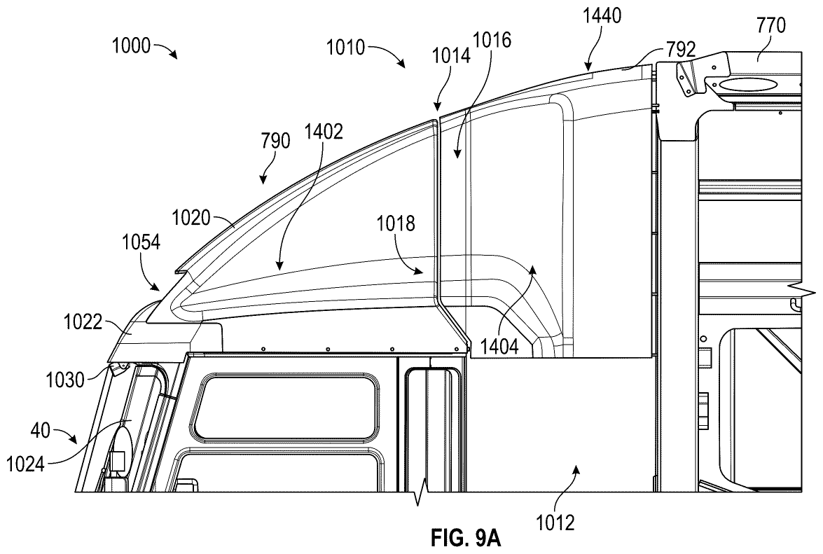

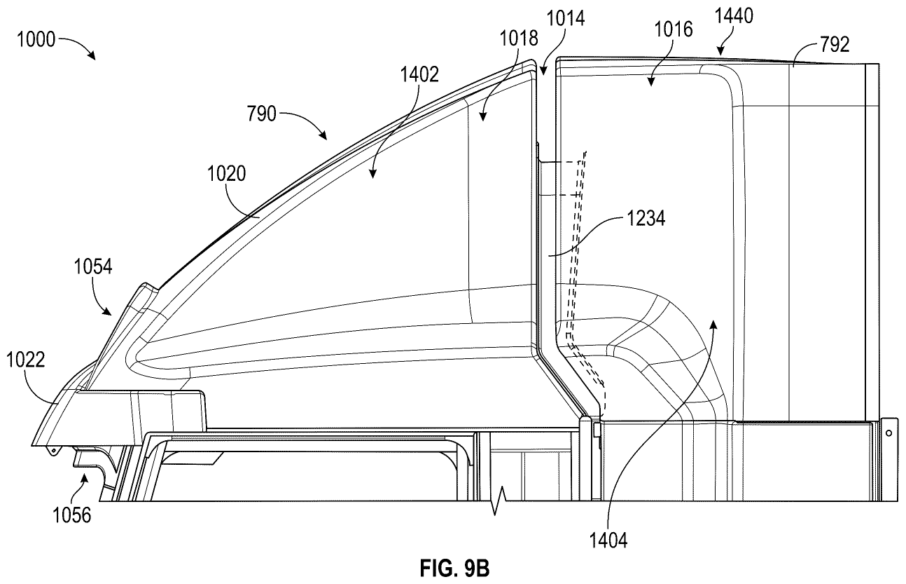

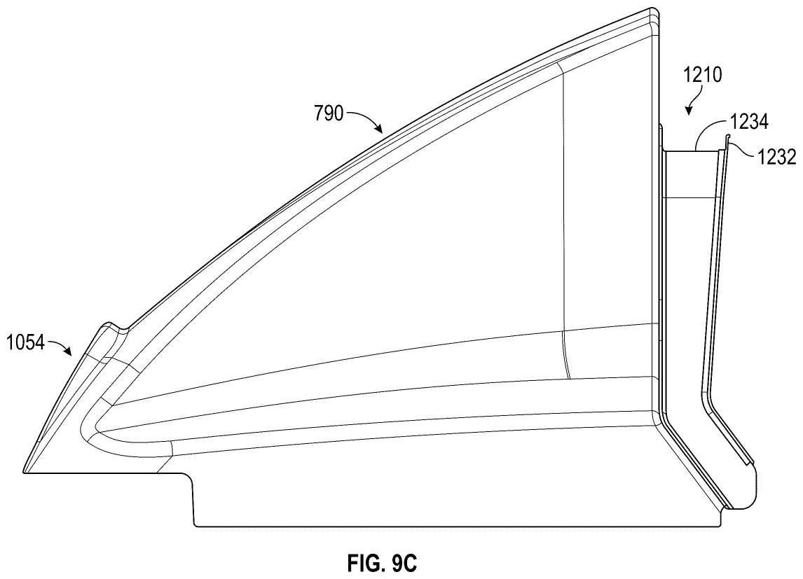

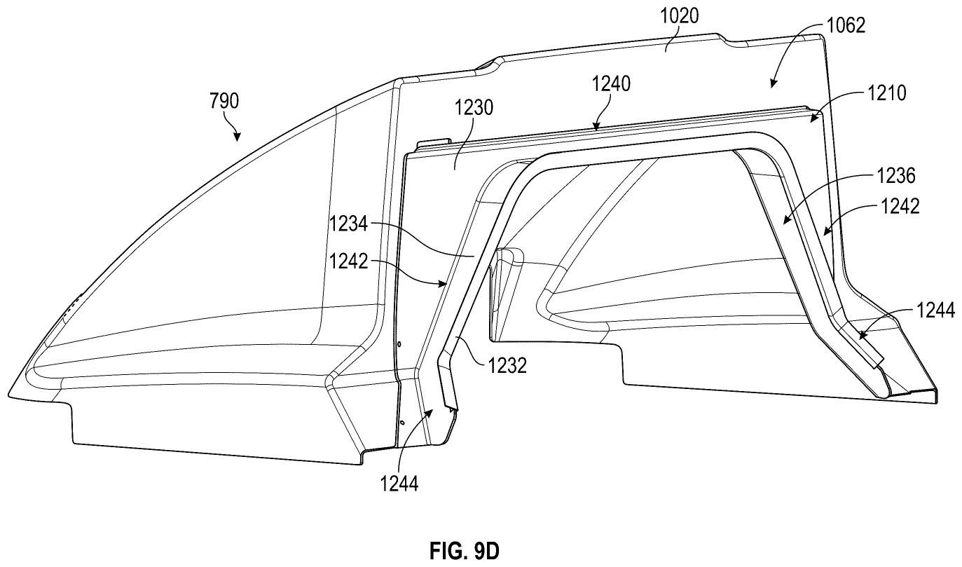

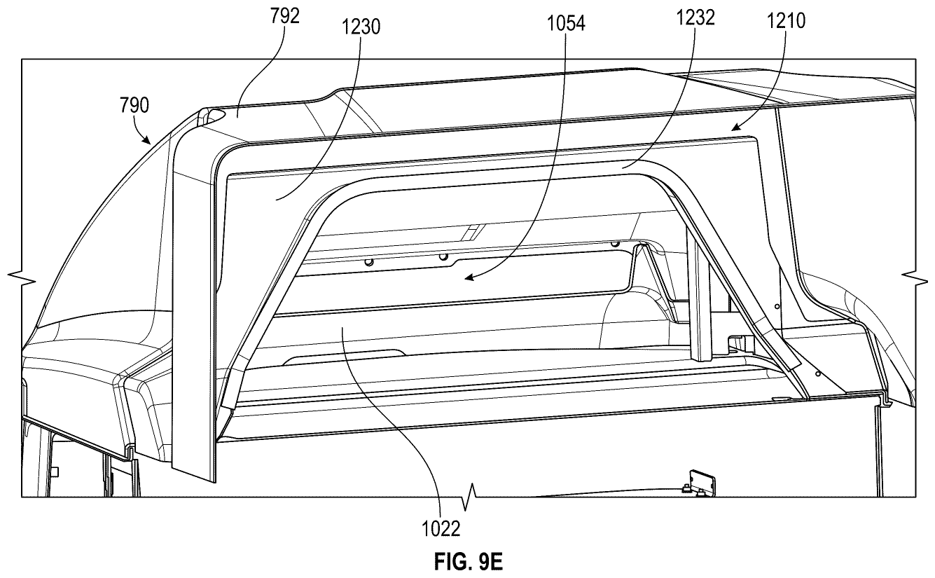

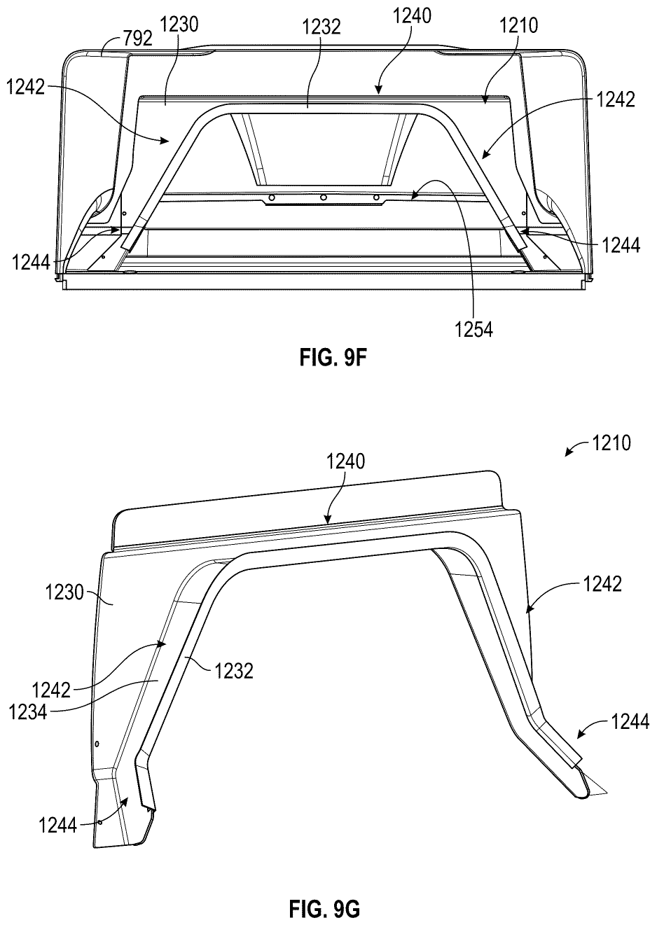

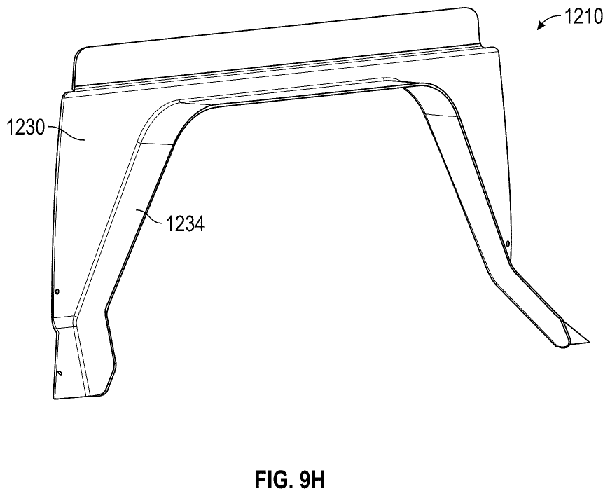

As best shown in FIG. 9A, a space or gap, shown as body gap 1014, is formed between the front shroud 790 and the rear shroud 792. The body gap 1014 extends laterally through the entirety of the cowl assembly 1010, from a left side of the cowl assembly 1010 to a right side of the cowl assembly 1010. The body gap 1014 extends vertically through the entirety of the cowl assembly 1010, from a top side of the cowl assembly 1010 to a bottom side of the cowl assembly 1010. The body gap 1014 extends from immediately behind the cab 40, upward and forward for a first distance, and vertically for a second distance to the top surface of the cowl assembly 1010. Accordingly, the front shroud 790 and the rear shroud 792 form corresponding overlapping sections. Specifically, rear shroud 792 forms an overhanging portion 1016 that extends forward from the rear shroud 792, and the front shroud 790 forms a recess 1018 that receives the overhanging portion 1016. The overhanging portion 1016 extends over the front shroud 790 such that upward movement of the overhanging portion 1016 is permitted.

Referring to FIGS. 7-9A and 10, the front shroud 790 is an assembly including a main portion or fixed portion, shown as hood 1020, and a replaceable portion or removable portion, shown as visor 1022. The hood 1020 is fixedly coupled to the roof of the cab 40, such that the hood 1020 remains during normal maintenance procedures. The hood 1020 is positioned directly above the cab 40 and extends along the body gap 1014. The visor 1022 is removably coupled to the hood 1020 and the cab 40, such that the visor 1022 can be removed and replaced (e.g., if the visor 1022 becomes damaged, to exchange the visor 1022 with a different aesthetic appearance or made from a different material, etc.). The visor 1022 is positioned at the front of the cab 40, directly above a front windscreen or windshield 1024 of the cab 40. The visor 1022 extends between the hood 1020 and the windshield 1024. This position at the front of the vehicle 1000 may make the visor 1022 more likely (e.g., than the hood 1020) to come into contact with debris, obstacles, or other objects that may contact the visor 1022, causing damage. By making this front portion of the cowl assembly 1010 easily replaceable, any damage caused to the front portion of the cowl assembly 1010 can be easily and quickly repaired. The visor 1022 also extends above and forward of the windshield 1024, protecting the windshield 1024 from debris falling downward toward the windshield 1024.

In some embodiments, the cab 40 includes a pair of guards or rails, shown as bars 1026. The bars 1026 are arranged substantially vertically, extending across the windshield 1024. The bars 1026 are laterally offset from one another. The bars 1026 may protect the windshield 1024 from contact with other objects. By way of example, the bars 1026 may prevent a refuse container from coming into contact with the windshield 1024.

The vehicle 1000 further includes a sensor, imaging device, or viewer, shown as front camera 1030, coupled to the cab 40. The front camera 1030 may provide image data regarding (e.g., showing) an area forward of the vehicle 1000. The image data may be utilized by a control system of the vehicle 10 (e.g., to provide information that is used by a controller to control operation of the vehicle 1000, to provide a real-time video output to an operator, etc.). The image data may also be used by a fan control system for controlling operations of the cooling fans onboard the refuse vehicle 1000, as will be further described. As shown, the front camera 1030 is positioned along a front side of the cab 40, above the windshield 1024, and below the visor 1022. The position of the visor 1022 above the front camera 1030 causes the visor 1022 to protect the front camera 1030 from falling rain and debris, preventing damage to the front camera 1030 and keeping the viewing portion (e.g., the lens) of the front camera 1030 clean. The visor 1022 includes a recessed portion, cutout, or notch, shown as camera cutout 1032, that is positioned around the front camera 1030. The camera cutout 1032 may provide clearance around the front camera 1030 to prevent the visor 1022 obstructing the view of the front camera 1030. In some embodiments, the front camera 1030 and the camera cutout 1032 are both approximately laterally centered relative to the cab 40. In some embodiments, the front camera 1030 is positioned between the bars 1026 such that the bars 1026 protect the front camera 1030 from contact with other objects.

Referring to FIGS. 11-14, the vehicle 1000 includes a cooling assembly, shown as core assembly 1040, positioned within a radiator volume 800 defined by the cowl assembly 1010. Specifically, the core assembly 1040 is positioned between the roof of the cab 40 and the front shroud 790. The core assembly 1040 includes a core 752 and a core 754 each coupled to a subframe, shown as core frame 1042. In other embodiments, the core assembly 1040 may include additional or fewer cores. The core frame 1042 is pivotally coupled to the cab 40 by a pair of couplers, shown as hinges 1044, such that the core assembly 1040 is rotatable relative to the cab 40 about a substantially vertical axis, shown as axis of rotation 1046. In other embodiments, the core frame 1042 is pivotally coupled to the body 770 by the hinges 1044. In such an embodiment, the core assembly 1040 may move relative to the cab 40 as the body 770 moves relative to the cab 40. The core 752 and the core 754 may be fixedly coupled to the core frame 1042, such that the core assembly 1040 moves together as one assembly about the axis of rotation 1046. The axis of rotation 1046 is laterally offset from the center of the vehicle 1000 to be positioned near the end of the core assembly 1040. As shown, the axis of rotation 1046 is offset to the left. In other embodiments, the arrangement is mirrored about a longitudinal center plane, such that the axis of rotation 1046 is offset to the right.

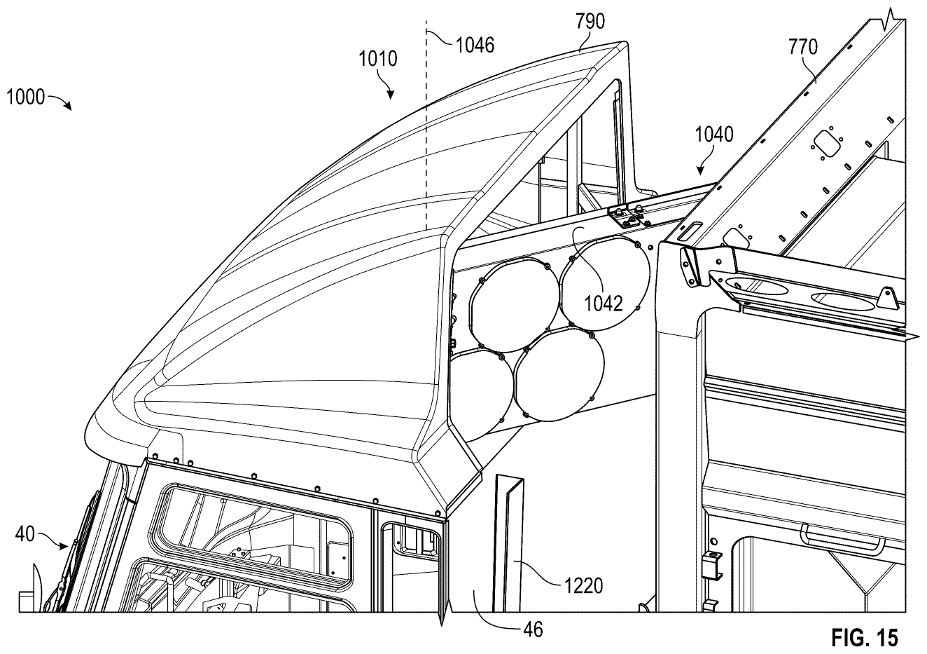

The core assembly 1040 is selectively repositionable about the axis of rotation 1046 between a default position, stored position, or use position, shown in FIG. 11, and an extended position or maintenance position, shown in FIG. 15. The core assembly 1040 may normally remain in the use position (e.g., unless the vehicle 1000 is undergoing maintenance). By way of example, the core assembly 1040 may include a latch, fastener, or another type of coupler that selectively limits (e.g., prevents) movement of the core assembly 1040 out of the use position. The core assembly may be released by the coupler and rotated backward toward the maintenance position. The maintenance position may facilitate access by a user (e.g., through the storage compartment 1012) to both the front and rear sides of the core assembly 1040 to facilitate cleaning and/or maintenance. The maintenance position may also facilitate access to the portion of the radiator volume 800 defined between the front shroud 790 and the cab 40.

Referring to FIG. 11, in the use position, the core assembly 1040 extends in a substantially vertical and lateral plane that is substantially perpendicular to a longitudinal axis. Specifically, the plane 830 and the plane 832 extend vertically and laterally and perpendicular to a longitudinal axis. In FIG. 11, the front shroud 790 is shown as being transparent for ease of viewing the core assembly 1040. Referring to FIG. 15, in the maintenance position, the core assembly 1040 rotationally offset about the axis of rotation 1046 (e.g., clockwise as viewed from above) relative to the use position. In the maintenance position, the core assembly 1040 extends rearward, beyond the front shroud 790, such that a space or gap is formed between the core assembly 1040 and the front shroud 790. The core assembly 1040 extends in a substantially vertical plane that is skewed relative to a longitudinal axis. Specifically, the plane 830 and the plane 832 extend vertically and are skewed relative to a longitudinal axis.

Referring to FIGS. 7-9A and 10-14, airflow through the core assembly 1040 generally flows along one of two airflow paths: a path 1050, and a path 1052. The path 1050 and the path 1052 may be consistent between multiple lateral positions, such that the path 1050 and the path 1052 can each reach the core 752 and the core 754. Although the path 1050 and the path 1052 generally indicate the direction of airflow through the radiator volume 800, it should be understood that the airflow may deviate from the exact paths shown (e.g., in order to fill the radiator volume 800 with pressurized air, due to turbulent flow, etc.).

The path 1050 enters the radiator volume 800 of the cowl assembly 1010 through a first opening, shown as inlet 1054, that is positioned along a front of the cowl assembly 1010. The inlet 1054 is defined by and between the hood 1020 and the visor 1022. Specifically, the top side of the inlet 1054 is defined by the hood 1020. The left, right, and bottom sides of the inlet 1054 are defined by the visor 1022. In other embodiments, the left side and/or the right side of the inlet 1054 are defined by the hood 1020.

As shown, the inlet 1054 extends laterally and vertically, the width of the inlet 1054 measured laterally being substantially larger (e.g., 5 times larger, 10 times larger, etc.) than the height of the inlet 1054 measured vertically. As shown, the inlet 1054 is generally oriented perpendicular to a longitudinal axis, such that airflow along the path 1050 enters the inlet 1054 longitudinally. In some embodiments, the vertical position of the inlet 1054 is selected such that airflow entering longitudinally through the inlet 1054 is permitted to pass directly to the core assembly 1040 (e.g., without encountering any obstructions). Such an arrangement may facilitate supplying unobstructed airflow to the core assembly 1040 through the inlet 1054 when the vehicle 1000 is traveling forward.

The path 1052 enters the radiator volume 800 of the cowl assembly 1010 through a second opening, shown as inlet 1056, that is positioned along the bottom of the cowl assembly 1010. The inlet 1056 is defined by and between the visor 1022 and the cab 40. Specifically, the top, left, and right sides of the inlet 1056 are defined by the visor 1022. The bottom side of the inlet 1056 is defined by the cab 40. Specifically, the bottom side of the inlet 1056 may be defined by an upper portion of the windshield 1024. As shown, the inlet 1056 extends laterally and longitudinally, the width of the inlet 1056 measured laterally being substantially larger (e.g., 5 times larger, 10 times larger, etc.) than the depth of the inlet 1056 measured longitudinally.

As shown, the inlet 1056 generally extends perpendicular to the front surface of the cab 40, such that the inlet 1056 generally faces downward. The front face of the cab 40 (e.g., the windshield 1024) is generally inclined, such that the front face extends upward as the cab 40 extends rearward. By way of example, the front face of the cab 40 may be offset from vertical by 5 degrees, 10 degrees, 15 degrees, 30 degrees, 45 degrees, etc.). Accordingly, longitudinal airflow (e.g., from the vehicle 1000 traveling forward) strikes the front face of the cab 40 and is directed upward, along the front face, toward the inlet 1056. The visor 1022 is curved to redirect the airflow in a longitudinal direction toward the core assembly 1040. Accordingly, due to the position of the visor 1022, the vehicle 1000 is able to direct airflow from the front face of the cab 40 toward the core assembly 1040, increasing the total airflow through the core assembly 1040 (e.g., the total of the airflow along the path 1050 and the path 1052) and more effectively cooling the core assembly 1040.

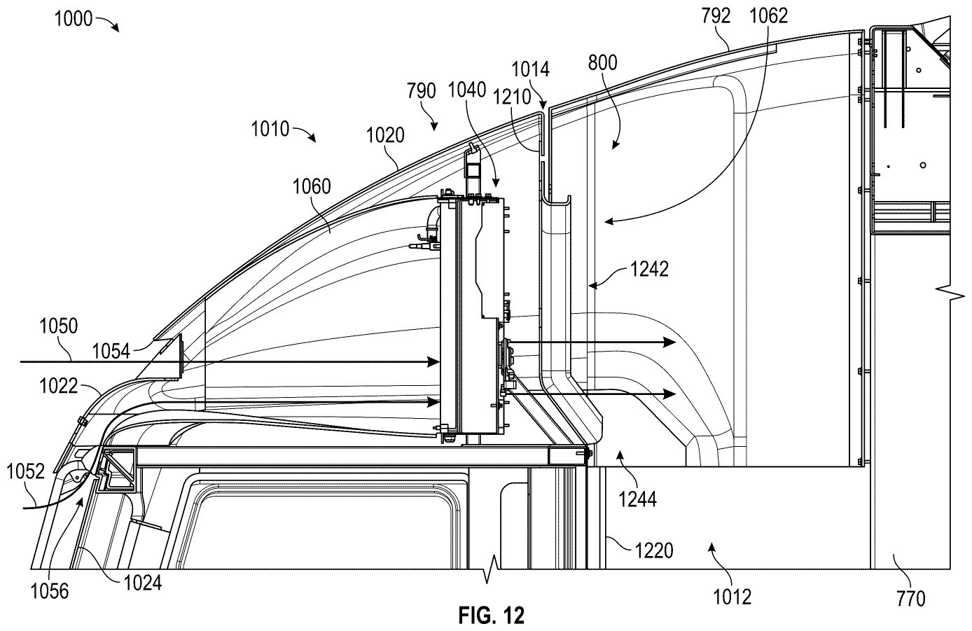

Referring to FIG. 12, the front shroud 790 further includes a flow collector or plenum, shown as sleeve 1060. The sleeve 1060 is positioned within the hood 1020 and coupled to the cab 40. The sleeve 1060 has a first end or opening that is in fluid communication with the inlet 1054 and the inlet 1056. Specifically, the sleeve 1060 is sealed against the hood 1020 and the cab 40 such that substantially all airflow through the inlet 1054 and the inlet 1056 passes into the sleeve 1060 through the first end. The sleeve 1060 has a second end or opening that is in fluid communication with the core assembly 1040. Specifically, the sleeve 1060 is sealed against the core assembly 1040 such that substantially all airflow through the second end of the sleeve 1060 passes into the core 752 or the core 754. Accordingly, the sleeve 1060 may facilitate forcing all of the airflow through the inlet 1054 and the inlet 1056 through the core 752 and/or the core 754. In some embodiments, the cross-sectional area of the sleeve 1060 generally increases as the sleeve 1060 passes rearward, from the inlet 1054 and the inlet 1056 toward the core assembly 1040.

As shown, the core assembly 1040 of the vehicle 1000 includes a series of air movers or blowers, shown as fans 760 and fans 762. The fans 760 are coupled to the core 752 and configured to direct air through the core 752 (e.g., across fins of the core 752). The fans 762 are coupled to the core 754 and configured to direct air through the core 754 (e.g., across fins of the core 754). The fans 760 and the fans 762 may be in a push configuration (e.g., such that air flows first through the fans and then into the corresponding core) and/or in a pull configuration (e.g., such that air flows first through the corresponding core and then into the fans). The fans 760 and/or the fans 762 may include the fans 724 and/or the fans 744.

Referring to FIGS. 12-14, an aperture or outlet, shown as outlet 1062, is defined between the hood 1020 and the top of the cab 40. The outlet 1062 is generally oriented parallel to the core assembly 1040. The outlet 1062 is fluidly coupled to the storage compartment 1012. As shown, the fans 760 and the fans 762 are positioned longitudinally between the cores 752 and 754 and the outlet 1062. In operation, the path 1050 extends from outside the vehicle 1000, through the inlet 1054, through the sleeve 1060, through the core 752 and/or the core 754, through the fans 760 and/or the fans 762, and out through the outlet 1062. The path 1052 extends from outside the vehicle 1000, through the inlet 1056, through the sleeve 1060, through the core 752 and/or the core 754, through the fans 760 and/or the fans 762, and out through the outlet 1062. The airflow that exits the outlet 1062 may have an elevated temperature after removing thermal energy from the core assembly 1040. The airflow that exits the outlet 1062 may exit the vehicle 1000 through a variety of paths. By way of example, the airflow may exit through a gap between two or more components (e.g., the body gap 1014, between the rear shroud 792 and the body 770, laterally outward from the side of the storage compartment 1012, downward through the chassis 20, etc.).

Although a specific air flow arrangement provided by the cowl assembly 1010 is shown and described herein, it should be understood that the air flow arrangement may be different in various embodiments, and that the inventive principles disclosed herein are not limited to a specific implementation of the cowl assembly 1010. Additionally, it should be understood that similar fan control system implementations as described herein may be performed regardless of the exact location of the heat exchangers along the refuse vehicle, and with minor variations in timing and/or actuation depending on the location of the heat exchanger(s) relative to the container lift system.

Referring to FIGS. 12-18, the vehicle further includes a drainage assembly, rain channel, or fluid diversion system, shown as drip channel assembly 1200. The drip channel assembly 1200 is configured to receive fluid that passes into the vehicle 1000 through the body gap 1014 and direct the received fluid away from certain components of the vehicle 1000. By way of example, the drip channel assembly 1200 may receive and direct water (e.g., from rain, when washing the vehicle 1000, etc.). By way of another example, in an embodiment where the vehicle 1000 is configured as a front-loading refuse vehicle (e.g., the refuse vehicle 100), the lift assembly 140 may raise a refuse container above the body gap 1014 in order to deposit refuse from the container into the hopper volume 132. During such a motion, fluid from the refuse container may drip through the body gap 1014 and into the drip channel assembly 1200. Accordingly, the drip channel assembly 1200 may improve the overall cleanliness of the vehicle 1000 and prevent fluid from reaching components that may be sensitive to contaminants or difficult to clean. By way of example, the drip channel assembly 1200 may prevent fluid from passing through the outlet 1062 and reaching the core assembly 1040, which may be difficult to clean, and which may be adversely affected by contamination from the fluid.

The drip channel assembly 1200 includes a first section, portion, or service panel, shown as upper channel portion 1210, and a pair of second sections or portions, shown as lower channel portions 1220. The upper channel portion 1210 is positioned above the cab 40 and is approximately laterally centered relative to the cab 40. The lower channel portions 1220 are each positioned below an end of the upper channel portion 1210. The upper channel portion 1210 directs fluid downward and laterally outward from a longitudinal centerline of the vehicle 1000. The lower channel portions 1220 are each positioned to be in fluid communication with an end of the upper channel portion 1210, such that fluid exiting the upper channel portion 1210 is received by one of the lower channel portions 1220. The lower channel portions 1220 each then direct the fluid further downward and laterally outward.

The upper channel portion 1210 includes a first flange or inner flange, shown as backing plate 1230, a second flange, shown as outer flange 1232, and a connecting portion, shown as channel bottom 1234. Together, the backing plate 1230, the outer flange 1232, and the channel bottom 1234 form a channel, gutter, trough, or drain of the upper channel portion 1210 having a U-shaped cross section. In some embodiments, the backing plate 1230, the outer flange 1232, and the channel bottom 1234 are integrally formed as a single, continuous piece. In other embodiments, the backing plate 1230, the outer flange 1232, and/or the channel bottom 1234 are formed separately and coupled to one another (e.g., using fasteners, using adhesive, etc.). The backing plate 1230 is removably coupled (e.g., by one or more fasteners) to the hood 1020 of the front shroud 790. The backing plate 1230 extends in a substantially vertical and lateral plane. The backing plate 1230 extends along the periphery of the outlet 1062 defined by the hood 1020, sealing the outlet 1062. The channel bottom 1234 extends reward from a bottom edge of the backing plate 1230. The channel bottom 1234 defines an aperture 1236, through which the airflow through the outlet 1062 is forced by the backing plate 1230. The aperture 1236 has a reduced cross-sectional area relative to the outlet 1062, but generally surrounds the fans 760 and 762. The outer flange 1232 is positioned at a distal end of the channel bottom 1234 and extends upward from the channel bottom 1234. In some embodiments, the backing plate 1230, the channel bottom 1234, and the outer flange 1232 are formed as a single, continuous piece.

The backing plate 1230, the channel bottom 1234, and the outer flange 1232 form the channel of the upper channel portion 1210, which includes a center portion 1240, a pair of intermediate portions or middle portions 1242, and a pair of drip portions or end portions 1244. The center portion 1240 is approximately laterally centered and extends laterally outward. The center portion 1240 is generally horizontal. In some embodiments, the center portion 1240 has an arc shape or a pair of pitched portions such that the center portion 1240 slopes downward as the center portion 1240 extends laterally outward from the center of the vehicle 1000.

Each end of the center portion 1240 meets one of the middle portions 1242. The middle portions 1242 are generally sloped downward and laterally outward. In some embodiments, the slopes of the middle portions 1242 are significantly steeper than the slope of the center portion 1240 (e.g., 30 to 60 degrees versus 0 to 10 degrees). In some embodiments, the center portion 1240 and the middle portions 1242 lie in a common lateral and vertical plane such that the center portion 1240 and the middle portions 1242 do not extend longitudinally forward or rearward (e.g., have a substantially constant longitudinal position).

The end of each middle portion 1242 meets one of the end portions 1244. The end portions 1244 are generally sloped downward and longitudinally rearward. In some embodiments, the lateral slopes of the end portions 1244 are significantly steeper than the slope of the center portion 1240 (e.g., 30 to 60 degrees versus 0 to 10 degrees). In some embodiments, each end portion 1244 lies in a longitudinal and vertical plane such that the end portions 1244 do not extend laterally inward or outward (e.g., have a substantially constant lateral position). The shapes and sizes of the center portion 1240, the middle portions 1242, and the end portions 1244 may be selected to match the shape and size of the body gap 1014, such that fluid entering the body gap 1014 at any point along the length of the body gap 1014 is captured by the channel of the upper channel portion 1210.

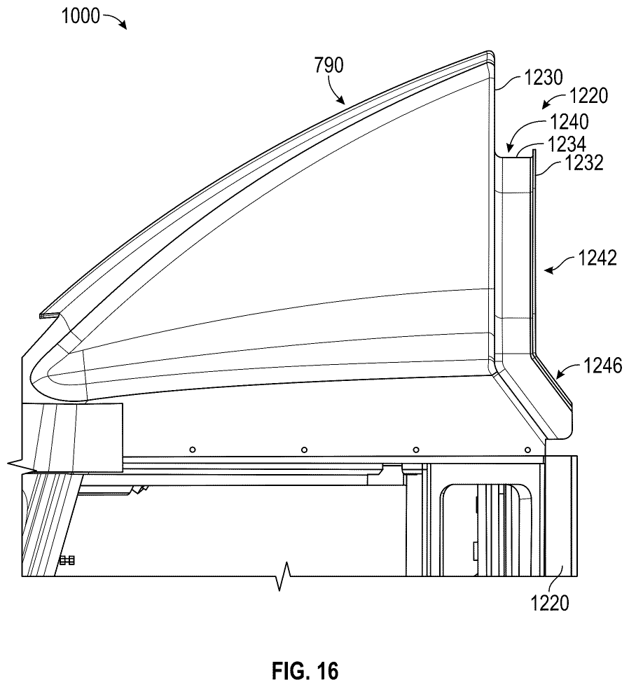

FIGS. 9B-9H illustrate an alternative configuration of the upper channel portion 1210. This alternative upper channel portion 1210 may be substantially similar to the upper channel portion 1210 shown in FIG. 16, except as otherwise specified herein, and may be utilized in place of the upper channel portion 1210 of FIG. 16. In the upper channel portion 1210 of FIGS. 9B-9H, the channel bottom 1234 and the outer flange 1232 are formed as separate pieces that are removably coupled to one another (e.g., by one or more fasteners). Such a configuration may facilitate manufacturing of the upper channel portion 1210. In the configuration of FIGS. 9B-9H, the center portion 1240 is wider (e.g., as measured perpendicular to the outer flange 1232) than the end portions 1244. The middle portions 1242 taper from the relatively large width of the center portion 1240 to the relatively small width of the end portions 1244. The end portions 1244 are generally sloped downward, longitudinally rearward, and laterally outward. In some embodiments, the lateral outward slopes of the end portions 1244 match (e.g., are substantially equal to) the lateral outward slopes of the middle portions 1242 (e.g., as shown in FIG. 9F).

The lower channel portions 1220 are positioned directly beneath the end portions 1244, such that fluid that drips off of the end portions 1244 is received by the lower channel portions 1220. The lower channel portions 1220 are each coupled (e.g., fixedly, removably, etc.) to a rear wall 46 of the cab 40. By way of example, the lower channel portions 1220 may be fastened or welded to the rear wall 46 of the cab 40. The lower channel portions 1220 extend rearward from the rear wall 46 of the cab 40. In some embodiments, the lower channel portions 1220 each have a U-shaped cross section, similar to the channel of the upper channel portion 1210. In such an embodiment, the U-shaped cross section opens laterally outward to facilitate capturing and retaining fluid drippings. The lower channel portions 1220 each slope downward and laterally outward. In some embodiments, the lower channel portions 1220 terminate near the bottom of the cab 40 and/or near the outer walls (e.g., left and right walls) of the cab 40.

In operation, fluid may pass through the body gap 1014. If the fluid is near the longitudinal center of the vehicle 10, the fluid is captured within the center portion 1240. If the fluid is to the left of center upon contact with the center portion 1240, gravity will force the fluid to flow laterally outward to the left. If the fluid is to the right of center upon contact with the center portion 1240, gravity will force the fluid to flow laterally outward to the right. The fluid may pass through the middle portion 1242 and the end portion 1244 and subsequently fall onto one of the lower channel portions 1220. The lower channel portions 1220 then direct the fluid even further laterally outward, away from any components that might be sensitive to contaminants. If the fluid initially enters the body gap 1014 farther from the longitudinal center of the vehicle 10, the fluid may fall onto a middle portion 1242, an end portion 1244, or a lower channel portion 1220 and be directed accordingly.

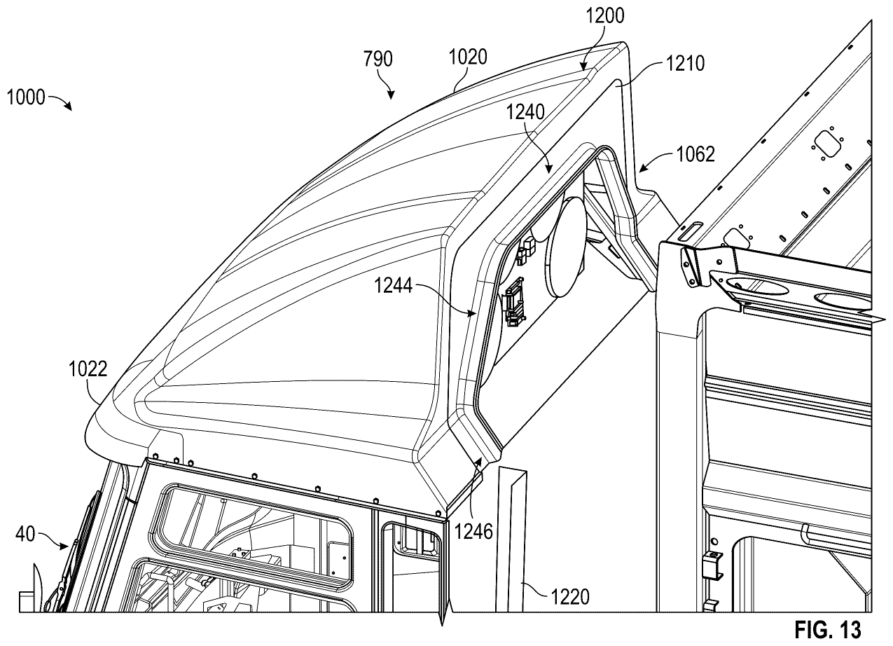

Referring to FIGS. 13 and 15, when installed, the upper channel portion 1210 may obstruct access to the core assembly 1040. Additionally, the upper channel portion 1210 may obstruct movement of the core assembly 1040, preventing the core assembly 1040 from reaching the maintenance position. In order to facilitate maintenance and cleaning of the core assembly 1040, the upper channel portion 1210 may be removably coupled to the front shroud 790 and/or the cab 40. By way of example, the front shroud 790 may be removably coupled to the front shroud 790 by a series of fasteners. By removing the fasteners, the upper channel portion 1210 may be disconnected from the front shroud 790 and removed. This removed state may facilitate movement of the core assembly 1040 and free access to the core assembly 1040 by a user. Additionally, removing the upper channel portion 1210 may facilitate cleaning the upper channel portion 1210. Once the cleaning and maintenance have been completed, the upper channel portion 1210 may be reattached to the front shroud 790. In other embodiments, the upper channel portion 1210 is fixedly and permanently coupled to the front shroud 790. By way of example, the upper channel portion 1210 may be formed as a single, continuous piece with the front shroud 790.

### Fan Control

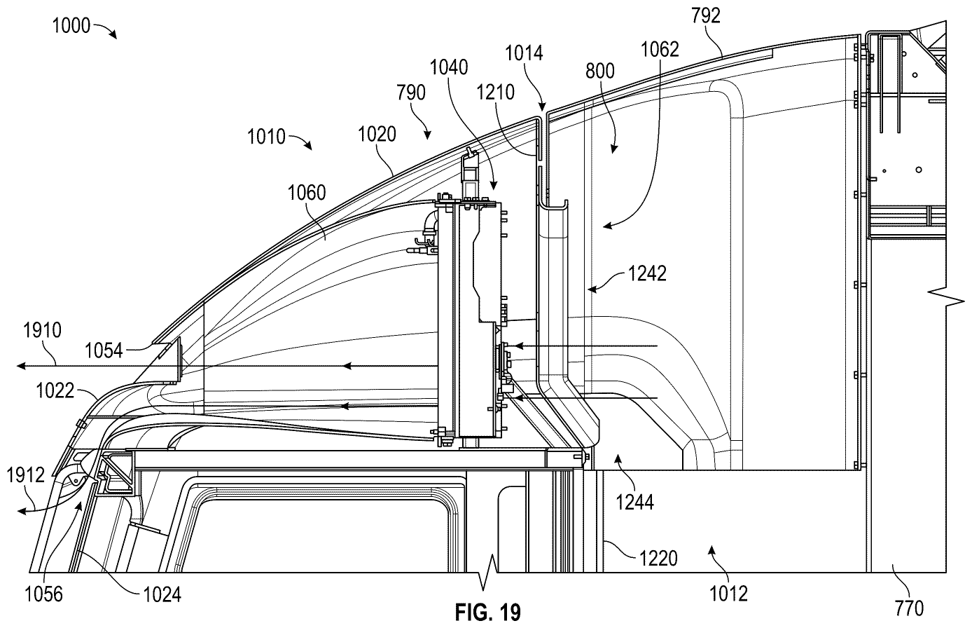

Referring now to FIG. 19, in some embodiments, one or more of the fans of the thermal management system (e.g., the fans 760 and/or the fans 762) may be selectively or controllably reversed (i.e., made to rotate in a direction opposite the direction of their normal rotation) to reverse the direction of airflow through the cowl assembly 1010 and the core assembly 1040. The thermal management system may include a fan control system that is configured to control the direction of fan operation to reduce the risk of ingesting debris and other contaminants into the heat exchangers during operation of an implement of the refuse vehicle, and/or depending on a state of operation or condition of the refuse vehicle. For example, the fan control system may be configured to control the direction of airflow through the cowl assembly 1010 when an implement (e.g., the lift system) of the vehicle 1000 is in operation, to prevent the introduction of debris into the cowl assembly 1010, through the inlet 1054 and/or the inlet 1056 (e.g., to prevent debris from entering the inlet 1054). Such an arrangement can prevent ingestion of dirt, sludge, and/or other debris from refuse containers being lifted over the refuse vehicle 100 from entering the cowl assembly 1010 and/or the heat exchangers. The fan control system may be configured to reverse the direction of airflow through the cowl assembly 1010 during the entire operation of the implement, or during a portion of the operation of the implement (e.g., a portion likely to create or agitate debris that may be drawn into the cowl assembly 1010), and/or based on another operating condition of the vehicle (e.g., during non-transit operations, while the vehicle is stationary, while the drive motors are not moving, etc.).

By way of example, when the vehicle 1000 is configured as a front-loading refuse vehicle, such as the refuse vehicle 100, the direction of airflow through the cowl assembly 1010 may be reversed when the lift assembly 140 is being operated to collect refuse, to prevent refuse, sludge, or other debris, dropped from a refuse container as it is being lifted over the cab 40 of the vehicle 1000, from being drawn into the cowl assembly 1010 through the inlet 1054 and/or the inlet 1056. The direction of airflow through the cowl assembly 1010 may be reversed during the entire refuse collection process, or the direction of airflow through the core assembly 1040 may be reversed during a portion of the collection process (e.g., when a refuse container being emptied into the body 770 is in front of, or above, the cab 40, when the inlet 1054 is disposed within debris or fluid receiving orientation with respect to the refuse container).

When reversed, airflow through the cowl assembly 1010 generally flows along one of two airflow paths: a path 1910, and a path 1912. In operation, the path 1910 extends from outside the vehicle 1000, through the outlet 1061, through the fans 760 and/or the fans 762, through the core 752 and/or the core 754, through the sleeve 1060, and out through the inlet 1054. The path 1912 extends from outside the vehicle 1000, through the outlet 1061, through the fans 760 and/or the fans 762, through the core 752 and/or the core 754, through the sleeve 1060, and out through the inlet 1056.

In some embodiments, the fans 760 and/or the fans 762 may be manually controlled to change the direction of airflow through the cowl assembly 1010. For example, the vehicle 1000 may include a switch or button, actuatable by the operator of the vehicle 1000, to alternate the polarity of a voltage provided to the fans 760 and/or the fans 762 to alternate their direction of rotation, and, therefore, the direction of airflow through the cowl assembly.

In some embodiments, the vehicle 1000 (e.g., the fan control system, the thermal management system 700, etc.) includes a controller 2000 to automatically control the fans 760 and/or the fans 762 to reverse the direction of airflow through the cowl assembly 1010 during the operation, or a portion of the operation, of an implement of the vehicle 1000, and/or based on another operating state or condition of the vehicle 1000. Such an implementation can eliminate reliance on operator input and can improve operating efficiency by coordinating reversal of fan operation with specific operating events that can cause ingestion of refuse into the cowl assembly.

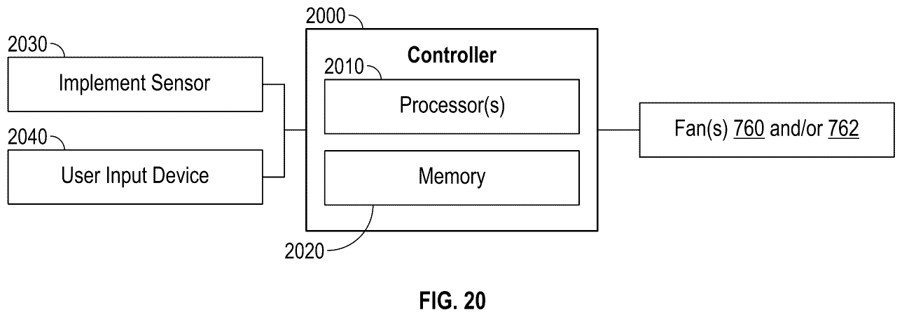

As shown in FIG. 20, controller 2000 includes one or more processors 2010 operatively connected to memory 2020 and configured to execute instructions stored on the memory 2020. The one or more processors 2010 can be implemented as general-purpose processors, application specific integrated circuits (ASICs), one or more field programmable gate arrays (FPGAs), a group of processing components, or other suitable electronic processing components.

The memory 2020 (e.g., memory, memory unit, storage device, etc.) can include one or more devices (e.g., RAM, ROM, flash memory, hard disk storage, etc.) for storing data and/or computer code for completing or facilitating the various processes, layers and modules described in the present application. The memory 2020 can be or include volatile memory or non-volatile memory. The memory 2020 can include database components, object code components, script components, or any other type of information structure for supporting the various activities and information structures described in the present application. According to some embodiments, memory 2020 is communicably connected to the one or more processors 2010 and includes computer code for executing one or more processes described herein.

In some embodiments, the controller 2000 is configured to receive, as an input, a signal (e.g., sensor data) from an implement sensor 2030. The implement sensor 2030 is configured to generate sensor data indicative of the operation of an implement of the vehicle 1000 (e.g., an implement whose operation requires the direction of airflow through the cowl assembly 1010 to be reversed to avoid the introduction of debris into the cowl assembly 1010). In some embodiments, the implement sensor 2030 is a sensor coupled to, or otherwise configured to generate sensor data indicative of activation or movement of an implement of the vehicle 1000. By way of example, where the vehicle 1000 is configured as a refuse vehicle, such as the refuse vehicle 100, the implement sensor 2030 may be a sensor configured to generate sensor data indicative of a position of a lift assembly (e.g., lift assembly 140), or a component of the lift assembly. The signal output by such a sensor can be used to determine whether the lift assembly is engaged in performing a refuse collection operation and/or to approximate the position of the lift assembly throughout the refuse collection operation, for example, to determine when the lift assembly is moving a refuse container in front of, or above, the cab 40 of the vehicle 1000 (e.g., adjacent to an airflow path upstream of and passing through the heat exchangers). By way of another example, the implement sensor 2030 may be an imaging sensor (e.g. front camera 1030) configured to generate sensor data indicative of an occurrence of a refuse collection operation, when the vehicle 1000 is configured as a refuse vehicle (e.g., refuse vehicle 100). In some embodiments, the implement sensor 2030 includes a proximity sensor configured to generate sensor data indicative of a position of the lift arms and/or the refuse container, an optical sensor configured to determine a change in the amount of light received by the sensor (e.g., which may be reduced as a refuse container passes in front of the sensor), or another type of sensor.

In some embodiments, the controller 2000 is additionally, or alternatively, configured to receive, as an input, a signal from a user input device 2040. The user input device 2040 may be a button, switch, lever, dial, touchscreen, etc., that an operator of the vehicle 1000 may actuate to indicate the operation of an implement of the vehicle 1000 whose operation requires the direction of airflow through the cowl assembly 1010 to be reversed to avoid the introduction of debris into the cowl assembly 1010. In some embodiments, the user input device 2040 is the same as, integral to, or coupled with, a control device configured to operate the implement of the vehicle 1000. By way of example, where the vehicle 1000 is configured as a refuse vehicle, such as the refuse vehicle 100, control devices (e.g., levers) for operating a lift assembly (e.g., lift assembly 140) may be configured to output a signal to the controller 2000 to indicate the operation of the lift assembly.

The controller 2000 is also configured to control the fans 760 and/or the fans 762 to selectively alternate the direction of airflow through the cowl assembly 1010. The controller 2000 may control when the fans 760 and/or the fans 762 are active. The controller 2000 may control the direction of rotation of the fans 760 and/or the fans 762 to alternate the direction of airflow through the cowl assembly 1010. The controller 2000 may include one or more motor control components (e.g., an H-bridge, a relay, a contactor) to control the flow and polarity of electrical current provided to the fans 760 and/or the fans 762. In some embodiments the controller 2000 is implemented on, or constitutes a subcomponent of, a vehicle controller. In other embodiments, the controller 2000 is a standalone controller, dedicated to the operation of the fans 760 and/or fan 762.

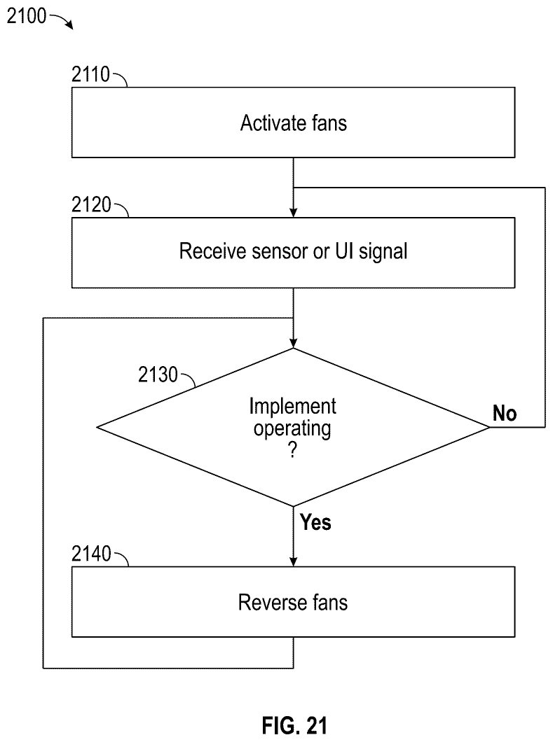

Referring to FIG. 21, a flow diagram of a method 2100 for controlling the fans 760 and/or the fans 762 to alternate the direction of airflow through the cowl assembly 1010 is shown, according to an exemplary embodiment. The method 2100 may be implemented on the controller 2000 and will therefore be described with reference to FIG. 20. In other embodiments, the method 2100 may include additional, fewer, and/or different operations.

The method 2100 includes energizing the fans 760 and/or the fans 762, at 2110. At operation 2110, the controller initially energizes the fans 760 and/or 762 to cause air flow through the cowl assembly 1010 substantially along the path 1050 and/or the path 1052. The controller may be configured to operate the fans 760 and/or 762 to maintain airflow along the path 1050 and/or the path 1052 under most conditions. In some embodiments, operation 2110 includes generating, by the controller, a first control signal to the fans to rotate the fans along a first direction responsive to an indication that cooling is required (e.g., from a thermostat along one or more cooling circuits, etc.).

In other embodiments, the controller may be configured to bypass operation 2110, such as when no cooling or fan operation is required before an implement of the vehicle is activated.

The method 2100 also includes receiving a sensor or user input signal, at 2120. In some embodiments, operation 2120 includes receiving, by the controller, a signal (e.g., sensor data) from a sensor configured to detect the operation of an implement of the vehicle 1000 whose operation requires the direction of airflow through the cowl assembly 1010 to be reversed to avoid drawing debris into the cowl assembly 1010, and/or from a user input device whose output indicates the same. The sensor may be the implement sensor 2030 and/or the user input device may be the user input device 2040. The signal received at operation 2120 may be in the form of a digital or analog electrical signal. Operation 2120 may include storing the sensor or user input signal in memory (e.g., memory 2020) for subsequent processing and/or analysis.

In other embodiments, operation 2120 may include receiving, by the controller, an indication of another vehicle condition under which the airflow direction through the heat exchangers and/or the cowl assembly should be reversed. For example, operation 2120 may include receiving, by the controller, and indication that the vehicle has stopped. In such embodiments, operation 2120 may include receiving an indication from the drive system that no power is being supplied to the drive motors, or from a speed sensor that indicates that the vehicle is stationary.

The method 2100 includes determining whether an implement of the vehicle 1000 is operating (or whether another vehicle condition under which the airflow direction through the heat exchangers and/or the cowl assembly should be reversed), and if so, whether the direction of airflow through the cowl assembly 1010 should be reversed, at 2130. In some embodiments, operation 2130 includes determining, by the controller, whether an implement of the vehicle 1000 is operating and/or a position of the implement relative to the cowl and/or airflow path based on the signal from the sensor. Operation 2130 may additionally include determining whether an operating implement is one whose operation requires that the airflow through the cowl assembly be reversed to avoid drawing debris into the cowl assembly 1010. If, at operation 2130, the controller determines that the implement of the vehicle 1000 is not operating (e.g., is deactivated), or that an operating implement is one whose operation does not require the direction of airflow through the cowl assembly 1010 to be reversed, the method 2100 returns to operation 2110, where the direction of airflow through the cowl assembly 1010 is maintained substantially along the path 1050 and/or the path 1052.

When it is determined, at operation 2130, that an implement of the vehicle 1000 is operating, and that the implement is one whose operation requires the direction of airflow through the cowl assembly 1010 to be reversed, the method 2100 includes the step of reversing the fans 760 and/or the fans 762, at 2140. At operation 2140, the controller may reverse the rotation of the fans 760 and/or 762 to create an airflow through the cowl assembly 1010 substantially along the path 1910 and/or the path 1912, and so that an inlet to the cowl assembly 1010 becomes an outlet to the cowl assembly 1010. In some embodiments, operation 2140 includes reversing, by the controller, the polarity of an electrical current to the fans 760 and/or the fans 762 to reverse the direction of airflow through the cowl assembly 1010, at operation 2140. The controller may be configured to maintain operation of the fans to direct air substantially along the path 1910 and/or the path 1912 for the entire operation of the implement, or airflow may be maintained substantially along the path 1910 and/or the path 1912 for only a portion of the operation of the implement. By way of example, where the vehicle is configured as a refuse vehicle (e.g. refuse vehicle 100), the controller, at operation 2140, may maintain airflow substantially along the path 1910 and/or the path 1912 for the entire duration of a refuse collection operation, or the controller may maintain airflow substantially along the path 1910 and/or the path 1912 for only a portion of the refuse collection operation (e.g., a portion of the refuse collection operation when a lift assembly is moving a refuse container in front of, or above, the cab 40 of the vehicle 1000 and/or past an inlet or other opening of the cowl assembly 1010). In some embodiments, operation 2140 includes maintaining operation of the fans in a reversed airflow condition until the vehicle begins transit operations (e.g., until the drive motors are activated to move the vehicle along a roadway).

After operation 2140, the method 2100 may return to operation 2130 to determine whether the implement is still in operation. If, at operation 2130, it is determined that the implement is no longer operating, or that the operation of the implement no longer requires the direction of airflow through the cowl assembly 1010 to be reversed, and/or that another operating state or condition of the vehicle no longer satisfies a reversed airflow condition, the method 2100 returns to operation 2110, where the rotational direction of the fans 760 and/or 762 is reversed such that the airflow through the cowl assembly 1010 is once again substantially along the path 1050 and/or the path 1052.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicles and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A refuse vehicle, comprising:
a chassis;
a body coupled to the chassis;
a cab coupled to the chassis forward of the body;
a shroud coupled to the cab, the shroud at least partially defining an inlet positioned along a front side of the shroud and an outlet positioned along a rear side of the shroud;
a heat exchanger disposed within the shroud;
a fan positioned to drive airflow through the shroud and the heat exchanger from the inlet toward the outlet;
a lift assembly rotatably coupled to the body and configured to perform a refuse collection operation, the refuse collection operation including engaging a refuse container and lifting the refuse container above the cab to deposit refuse from the refuse container into the body; and
a controller configured to:
determine whether the refuse collection operation is being performed; and
control the fan to drive airflow through the shroud, from the outlet toward the inlet, in response to determining that the refuse collection operation is being performed.

2. The refuse vehicle of claim 1, further comprising a lift sensor operably coupled with the controller and configured to generate sensor data indicative of a position or movement of the lift assembly, wherein, the controller is further configured to:
receive the sensor data; and
determine that the refuse collection operation is being performed based on the sensor data.

3. The refuse vehicle of claim 2, wherein the lift sensor comprises an imaging device coupled to the cab and oriented to capture a view forward of the cab.

4. The refuse vehicle of claim 1, further comprising a selective user input device operably coupled with the controller and actuatable to generate an input signal, wherein the controller is further configured to:
receive the input signal; and
determine that the refuse collection operation is being performed based on the input signal.

5. The refuse vehicle of claim 1, wherein the controller is further configured to control the fan to drive airflow through the shroud and the heat exchanger, from the inlet toward the outlet, in response to determining that the refuse collection operation has ceased.

6. The refuse vehicle of claim 1, wherein the controller is further configured to control the fan to drive airflow through the shroud and the heat exchanger, from the outlet toward the inlet, for only a portion of the refuse collection operation.

7. The refuse vehicle of claim 1, wherein the controller is further configured to control the fan to drive airflow through the shroud and the heat exchanger, from the outlet toward the inlet, until the refuse vehicle begins transit operations.

8. A vehicle, comprising:
a chassis;
a cab coupled to the chassis;
a shroud coupled to the cab, the shroud at least partially defining a first airflow opening and a second airflow opening;
a heat exchanger disposed within the shroud;
a fan positioned to drive airflow through the shroud and the heat exchanger from the first airflow opening toward the second airflow opening;
a working component coupled to the chassis and movable relative to the cab; and
a controller configured to:
determine whether the working component is in operation; and
control the fan to drive airflow through the shroud and the heat exchanger, from the second airflow opening toward the first airflow opening, to reduce ingestion of debris associated with operation of the working component, in response to determining that the working component is in operation.

9. The vehicle of claim 8, further comprising a sensor operably coupled with the controller and configured to generate sensor data indicative of a position or movement of the working component;
wherein, the controller is further configured to:
receive the sensor data; and
determine that the working component is in operation based on the sensor data.

10. The vehicle of claim 9, wherein the sensor comprises an imaging device coupled to the cab.

11. The vehicle of claim 8, further comprising a selective user input device operably coupled with the controller and actuatable to generate an input signal;
wherein, the controller is further configured to receive the input signal; and
determine that the working component is in operation based on the input signal.

12. The vehicle of claim 8, wherein the controller is further configured to control the fan to drive airflow through the shroud and the heat exchanger, from the first airflow opening toward the second airflow opening, in response to determining that operation of the working component has ceased.

13. The vehicle of claim 8, wherein the controller is further configured to control the fan to drive airflow through the shroud and the heat exchanger, from the second airflow opening toward the first airflow opening, for only a portion of the operation of the working component.

14. The vehicle of claim 8, wherein the controller is further configured to control the fan to drive airflow through the shroud and the heat exchanger, from the second airflow opening toward the first airflow opening, while the vehicle is stationary.

15. A method for controlling airflow through a shroud disposed on a cab of a refuse vehicle, the method comprising:
causing, by a controller, a fan disposed within the shroud to drive airflow through the shroud, from an inlet defined at least in part by the shroud toward an outlet defined at least in part by the shroud;
receiving, by the controller, an indication of a first condition; and
in response to receiving the indication of the first condition, causing, by the controller, the fan to drive airflow through the shroud, from the outlet toward the inlet.

16. The method of claim 15, wherein the first condition comprises actuation of a lift assembly of the refuse vehicle to engage a refuse container and lift the refuse container above the cab to deposit refuse from the refuse container into a body of the refuse vehicle.

17. The method of claim 16, wherein driving airflow from the outlet toward the inlet reduces ingestion of debris into the inlet during actuation of the lift assembly.

18. The method of claim 16, further comprising:
receiving, by the controller, an indication of a second condition; and
in response to receiving the indication of the second condition, causing, by the controller, the fan to drive airflow through the shroud, from the inlet toward the outlet.

19. The method of claim 18, wherein the second condition comprises one of deactivation of the lift assembly or transport of the refuse vehicle.

20. The method of claim 16, wherein the indication of the first condition comprises one of:
sensor data received from a sensor associated with the lift assembly and configured to generate sensor data indicative of a position or movement of the lift assembly; or
an input signal received from a selective user input device actuatable to generate the input signal.
